(19) United States
(12) Patent Application Publication
(10) Pub. No.: US 2011/0005313 A1
(43) Pub. Date: Jan. 13, 2011

(54) HUMIDITY SENSOR

(76) Inventor: Matthew Vernon, Albuquerque, NM (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/778,659

(22) Filed: May 12, 2010

Related U.S. Application Data
(60) Provisional application No. 61/216,092, filed on May 12, 2009.

(51) Int. Cl. G01N 27/22

(52) U.S. Cl. 73/335.04

(57) ABSTRACT

A humidity sensor that includes a humidity sensitive material. A sensing circuit associated with the humidity sensitive material estimates the ambient humidity based upon the humidity sensitive material. A heating element is associated with the humidity sensitive material. A temperature circuit temporarily increases the temperature proximate the humidity sensitive material and thereafter the sensing circuit estimates the ambient humidity.

### CROSS-REFERENCE TO RELATED APPLICATIONS

This application claims the benefit of Provisional App. No. 61/216,092, filed May 12, 2009.

### BACKGROUND OF THE INVENTION

The present invention relates to a humidity sensor.

Humidity relates to the amount of water vapor that exists in the air. One measure of humidity is relative humidity which is the amount of water vapor in a sample of air compared to the maximum amount of water vapor the air can hold at any specific temperature. Relative humidity may be defined as the ratio of the partial pressure of water vapor in a gaseous mixture of air and water vapor to the saturated vapor pressure of water at a given temperature. Relative humidity may be expressed as a percentage in the following manner:

$$RH = \frac{{p}_{( {H}_{2} O )}}{{p}_{( {H}_{2} O )}^{*}} \times 100 \%$$

where P(H₂O) is the partial pressure of water vapor in the gas mixture; P*(H₂O) is the saturation vapor pressure of water at the temperature of the gas mixture; and RH is the relative humidity of the gas mixture being considered.

Another measure of humidity is absolute humidity which is the quantity of water in a particular volume of air. The amount of vapor in that volume of air is the absolute humidity of that volume of air. One equation representing absolute humidity (e.g., AH) is the mass of water vapor m_{w}, per cubic meter of air, Vₐ.

$$AH = \frac{{m}_{w}}{{V}_{a}}$$

Specific humidity is the ratio of water vapor to air (including water vapor and dry air) in a particular volume. Specific humidity ratio is expressed as a ratio of kilograms of water vapor, m_{w}, per kilogram of mixture, mₜ. The specific humidity (e.g., SH) ratio can be expressed as:

$$SH = \frac{{m}_{w}}{{m}_{a} + {m}_{v}}$$

Specific humidity is related to a mixing ratio (and vice versa) by:

$$SH = \frac{MR}{1 + MR}$$

$$MR = \frac{SH}{1 - SH}$$

Other measures of humidity may be used, typically depending on the particular application.

Humidity sensors tend to have limited accuracy in providing a repeatable measurement due to hysteresis within the sensor itself. A humidity sensor with hysteresis may be in any number of states, independent of the inputs to the humidity sensor. More precisely, the hysteresis of a humidity sensor exhibits path-dependence, or rate-independent memory. Accordingly, humidity sensors with hysteresis are problematic to predict the output without knowing the history of the input. Thus, in order to predict the output, the path that the input followed before it reached its present value needs to be known.

Some humidity sensors have limited hysteresis relative to sensor repeatability but tend to be relatively expensive. While accurate, such sensors tend to be to expensive for many applications. Other humidity sensors have significant hysteresis relative to sensor repeatability but tend to be relatively inexpensive. While sufficiently inexpensive, such sensors may be too inaccurate for many applications.

What is desired therefore, is a relatively inexpensive humidity sensor that has relatively low hysteresis relative to sensor repeatability.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an exemplary humidity sensor.

FIG. 2 illustrates another exemplary humidity sensor.

FIG. 3 illustrates an exemplary decrease in humidity.

FIG. 4 illustrates an exemplary increase in humidity.

FIG. 5 illustrates an exemplary humidity sensing system.

FIG. 6 illustrates another exemplary humidity sensing system.

### DETAILED DESCRIPTION OF PREFERRED EMBODIMENT

One example of a humidity sensor is a capacitance-based humidity sensor element in the form of a thin flexible film. Referring to FIG. 1, a capacitance-based humidity sensor 10 includes a dielectric film core 11 having a pair of electrically conductive layers 12, 13 on opposite sides thereof. Contacts 14, 16 on layers 12, 13 connect the sensor element to a source of electrical current.

The dielectric film 11 is a water absorbing material having a dielectric constant which changes predictably (preferably, essentially linearly) as a function of relative humidity. The dielectric film may have backbone chains containing heterocyclic units in which one or more atoms in the heterocyclic unit is nitrogen, one or more carbon atoms in the heterocyclic unit has an oxygen atom double bonded to it (i.e., the unit contains one or more keto groups), and the heterocyclic unit is bonded into the polymer backbone through one or more nitrogen atoms of the heterocyclic ring. The resulting change in capacitance for a given change in humidity is preferably constant over a temperature range of about 15° to 50° C., allowing the humidity sensor to be employed in harsh conditions.

The dielectric film may be made as thin as possible for the desired capacitance and film strength. The film is preferably thinner than the conductive layers. The film 11 may, for example, have a thickness of 0.005 inches or less. The resulting element 10 is relatively light and thin. The dielectric layer 11 may be made prior to the formation of the outer bonded conducting layers 12 and 13.

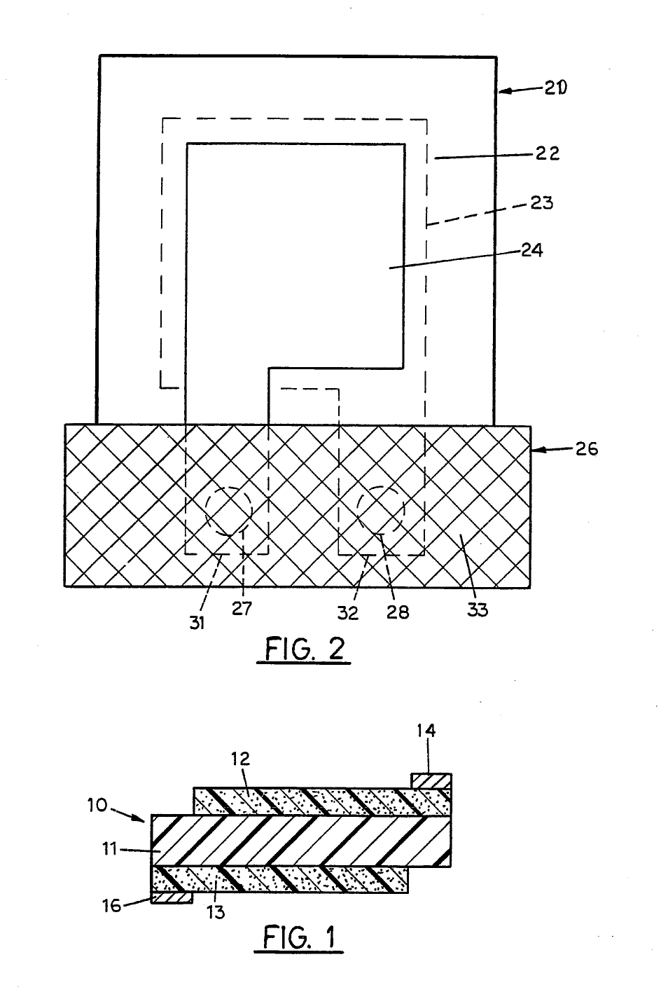

FIG. 2 illustrates a humidity sensor 20 that includes a dielectric film 22 with a pair of conductive layers 23, 24 formed on opposite sides of film 22, together with a holder 26. Outer conductive layers 23, 24 form the plates of the capacitor. Layers 23, 24 cover selected areas on opposite sides of dielectric film 22. The overlapping areas of the conductive layers 23, 24 comprise the active portion of the capacitance humidity sensor. Regions 27, 28 of conductive material are applied over the conducting layers 23, 24 in areas where the layers 23, 24 do not overlap, for example in elongated tab portions 31, 32, which extend into holder 26. Electrical contact is made to the regions 27, 28 by one or more conductive metal plates 33 forming part of holder 26 used to mount the humidity sensor. Alternatively, it is to be understood that any humidity sensor of any configuration and design may be used.

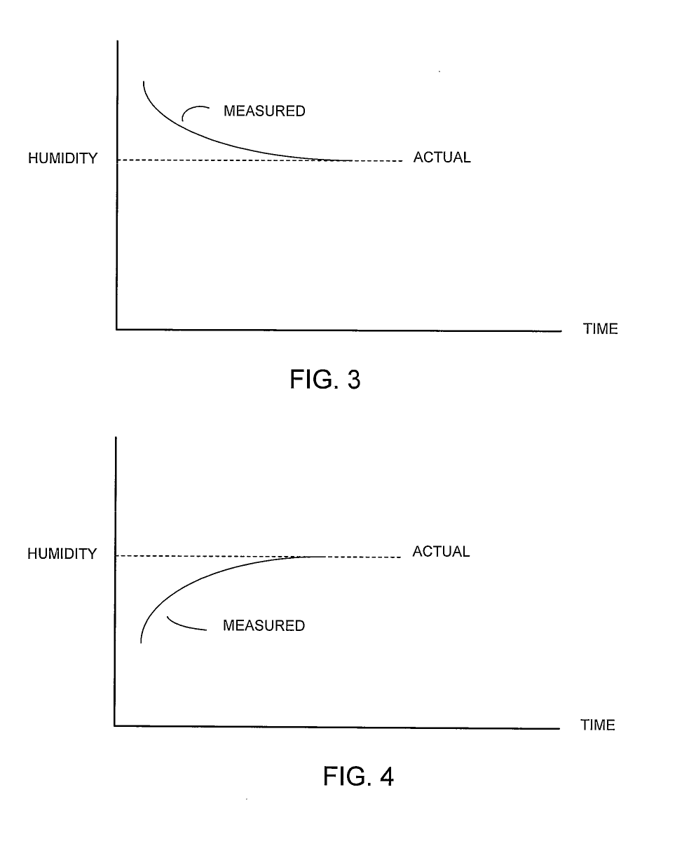

Referring to FIG. 3, typically a humidity sensor has a characteristic that for a relatively quick change from an initial ambient humidity to a lower ambient humidity results in a decrease in the sensed humidity value over time. The curve depends on the previous state of the humidity sensor, the humidity levels, among a variety of other factors. In any case, it can be observed that the sensed humidity value does not typically actually reach the “actual” humidity value.

Referring to FIG. 4, typically a humidity sensor has a characteristic that for a relatively quick change from an initial ambient humidity to a higher humidity results in an increase in the sensed humidity value over time. The curve depends on the previous state of the humidity sensor, the humidity levels, among a variety of other factors. In any case, it can be observed that the sensed humidity value does not typically actually reach the “actual” humidity value.

Depending on whether the humidity changed from a lower value to a higher value, or from a higher value to a lower value, the hysteresis results in an offset to a respective side of the actual humidity value. In general, the direction of the hysteresis is generally unknown to the sensor unless the system tracks the history of the changes in humidity. Having hysteresis which is offset above and offset below generally results in a total hysteresis that is generally twice the one-sided hysteresis of the sensing device. Moreover, since the direction of the humidity change is unknown, simply calibrating the device is not suitable to remove a substantial part of the hysteresis.

In order to implement a relatively inexpensive humidity sensor that tends to have significant hysteresis, it was determined that it is desirable to have a known direction from which the hysteresis occurs. Since the ambient humidity tends to shift relatively slowly over time, it is desirable to use a heating device proximate the humidity sensor to temporarily decrease the local humidity. Preferably the heater is incorporated on the same integrated package as the humidity sensor. By decreasing the local humidity proximate the humidity sensor, then thereafter sensing the ambient humidity, it is known the measurement will be from a single side such as shown in FIG. 4. In this manner, the offset is generally known and may be calibrated for. Also, the direction of the curve will be generally known and the characteristics of the curve are likewise generally known.

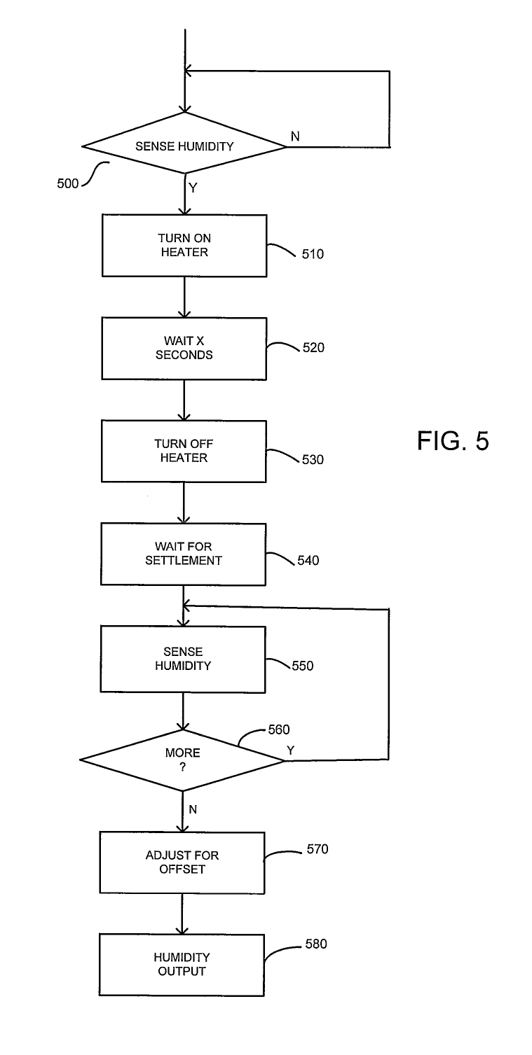

Referring to FIG. 5, a determination is made that it is desirable to sense humidity 500. When it is desired to measure the humidity, it is desirable to decrease the local humidity proximate the sensor. A heater proximate the humidity sensor is turned on 510. The heater remains turned on for x seconds, depending on the heat provided and the length of time desirable to sufficiently change the local humidity 520. The heater is then turned off or otherwise reduced in its temperature 530. Preferably, the system waits for sufficient time for the humidity sensor to settle 540. Thereafter, the humidity is sensed by the humidity sensor 550. A determination 560 is made whether to obtain additional measurements of the humidity. Preferably, the system obtains a plurality of humidity measurements from which to determine the humidity, such as averaging a plurality of measurements or otherwise calculating a humidity value. After obtaining a sufficient measurements, the system may then modify the resulting value to adjust for the hysteresis 570. Since the hysteresis offset, its magnitude, and its direction is generally known, it may be calibrated out of the measurement. The adjusted hysteresis 580 is provided as an output.

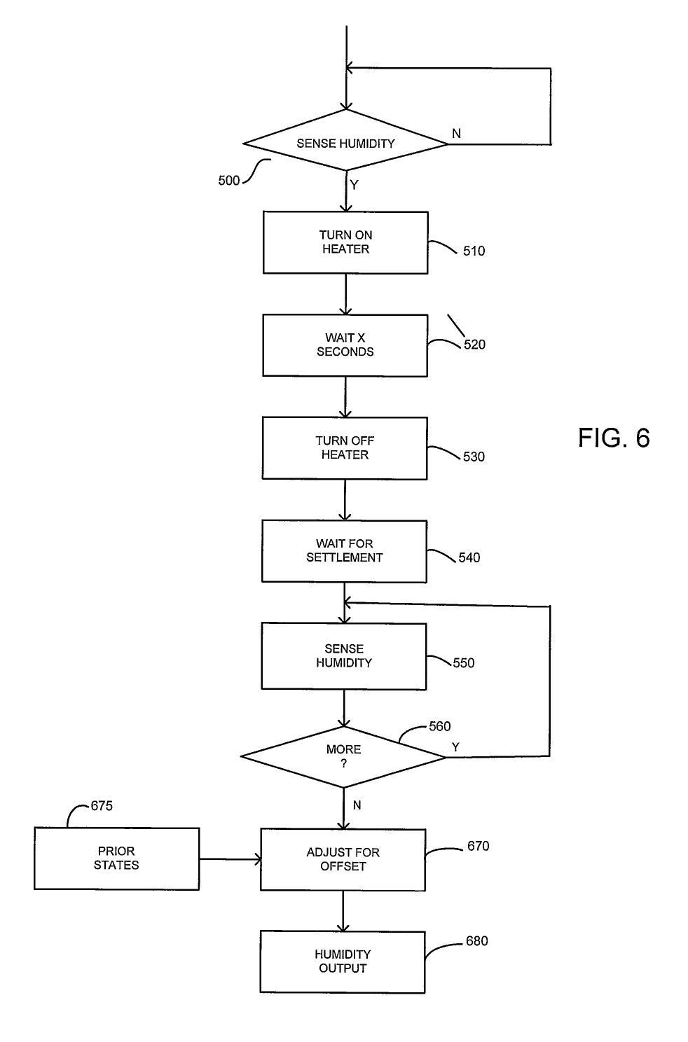

Referring to FIG. 6, a modified technique uses a memory that includes the recent past states of the humidity sensor. The hysteresis offset process 670 is modified based upon the past state of the device 675. In this manner, the hysteresis can be more accurately adjusted. The corrected sensed hysteresis 680 is provided as an output.

It is preferable that the heat provided to the humidity sensor provides a change of less than 5% in humidity, and preferably a change of less than 2% in humidity. Preferably, measurements are not made during the time that additional heat is being provided. Similarly, the process may be changed by using a cooling element and measuring the change in humidity.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A humidity sensor comprising:
(a) a humidity sensitive material;
(b) a sensing circuit associated with said humidity sensitive material that estimates the ambient humidity based upon said humidity sensitive material;
(c) a heating element associated with said humidity sensitive material;
(d) a temperature circuit that temporarily increases the temperature proximate said humidity sensitive material and thereafter said sensing circuit estimates said ambient humidity.

2. The sensor of claim 1 wherein said humidity sensor is a capacitance based sensor.

3. The sensor of claim 2 wherein said humidity sensor has a dielectric film core.

4. The sensor of claim 3 wherein said film core has a pair of electrically conductive layers on opposite sides thereof.

5. The sensor of claim 1 wherein said humidity sensitive material has an essentially linear function of relative humidity.

6. The sensor of claim 1 wherein said humidity sensitive material has backbone chains containing heterocyclic units.

7. The sensor of claim 6 wherein said heterocyclic unit has an oxygen atom double bonded.

8. The sensor of claim 6 wherein said heterocyclic units include at least one keto group.

9. The sensor of claim 1 wherein said humidity sensitive material is less than 0.005 inches thick.

10. The sensor of claim 1 wherein said sensing circuit estimates said ambient humidity after said temperature substantially reaches a steady state.

11. A humidity sensor comprising:
(a) a humidity sensitive material;
(b) a sensing circuit associated with said humidity sensitive material that estimates the ambient humidity based upon said humidity sensitive material;
(c) a cooling element associated with said humidity sensitive material;
(d) a temperature circuit that temporarily decreases the temperature proximate said humidity sensitive material and thereafter said sensing circuit estimates said ambient humidity.

12. The sensor of claim 11 wherein said humidity sensor is a capacitance based sensor.

13. The sensor of claim 12 wherein said humidity sensor has a dielectric film core.

14. The sensor of claim 13 wherein said film core has a pair of electrically conductive layers on opposite sides thereof.

15. The sensor of claim 11 wherein said humidity sensitive material has an essentially linear function of relative humidity.

16. The sensor of claim 11 wherein said humidity sensitive material has backbone chains containing heterocyclic units.

17. The sensor of claim 16 wherein said heterocyclic unit has an oxygen atom double bonded.

18. The sensor of claim 16 wherein said heterocyclic units include at least one keto group.

19. The sensor of claim 11 wherein said humidity sensitive material is less than 0.005 inches thick.

20. The sensor of claim 11 wherein said sensing circuit estimates said ambient humidity after said temperature substantially reaches a steady state.
